(19) United States
(12) Patent Application Publication
(10) Pub. No.: US 2024/0379272 A1
(43) Pub. Date: Nov. 14, 2024

(54) INDUCTOR ASSEMBLY AND INDUCTOR DEVICE

(71) Applicant: Lanto Electronic Limited, Kunshan City (CN)

(72) Inventors: Dongchang FAN, Kunshan City (CN); Yi ZHOU, Kunshan City (CN); Yanlei YANG, Kunshan City (CN); Tao ZHU, Kunshan City (CN)

(73) Assignee: Lanto Electronic Limited, Kunshan City (CN)

(21) Appl. No.: 18/379,042

(22) Filed: Oct. 11, 2023

(30) Foreign Application Priority Data
May 8, 2023 (CN) 202310511277.X

(51) Int. Cl. H01F 27/04; H01F 1/03; H01F 27/02; H01F 27/16; H01F 27/29

(52) U.S. Cl. CPC H01F 27/04; H01F 1/0306; H01F 27/025; H01F 27/16; H01F 27/29

(57) ABSTRACT

Provided are an inductor assembly and an inductor device. The inductor assembly includes an inductor housing and an inductor module. The inductor housing includes a housing and a connecting member which are integrally formed. The housing is a sealed structure, and the connecting member is located outside the housing. The housing is hollow, and is provided with a wiring hole. The connecting member is configured to connect to an object to be installed. The inductor module is fixedly installed in the housing, and the inductor module includes a magnetic core and a coil.

### CROSS-REFERENCE TO RELATED APPLICATIONS

This disclosure claims priority to Chinese Patent Application No. 202310511277X filed May 8, 2023, the disclosure of which is incorporated herein by reference in its entirety.

### TECHNICAL FIELD

The present disclosure relates to the field of inductor technology, and in particular, to an inductor assembly and an inductor device.

### BACKGROUND

A boost inductor is used in conjunction with a switching device in the boost circuit to achieve an output voltage higher than an input voltage through charging and discharging. Simply put, the boosting process is an energy transfer process of an inductor. When being charged, the inductor absorbs energy, and when being discharged, the inductor releases energy. If the capacitance is sufficiently large, a continuous current can be maintained at the output end in the process of discharging. If the process of turning on and off is repeated continuously, a voltage higher than the input voltage can be obtained between two terminals of a capacitor.

In the existing art, the boost inductor at least includes a magnetic core and a coil wound outside the magnetic core, the magnetic core is connected to the coil into one piece. For example, the Chinese Patent No. 204668123 discloses an adjustable inductor, which includes a housing, a base and an inductor body. The housing is disposed above the base, and the inductor body is disposed between the housing and the base, and when to assembly, it is necessary to weld or fix in advance a bracket on an assembly (such as a frame of a car) to be assembled, and then weld or fix the base on the bracket. It can be seen that in the existing art, there are many installation steps for the boost inductor, and the installation process is complex, resulting in low installation efficiency of the boost inductor.

### SUMMARY

The present disclosure provides an inductor assembly and an inductor device, which can be easily installed on an assembly to be assembled and has a high installation efficiency.

As envisioned above, the technical solutions adopted by the present disclosure are as follows.

An inductor assembly includes an inductor housing and an inductor module.

The inductor housing includes a housing and a connecting member which are integrally formed. The housing is a sealed structure, the connecting member is located outside the housing, the housing is hollow, the housing is provided with a wiring hole, and the connecting member is configured to connect to an object to be installed.

The inductor module is fixedly installed in the housing, and includes a magnetic core and a coil.

In an embodiment, the inductor assembly further includes a support plate fixedly installed inside the housing, and the support plate is configured to limit the inductor module inside the housing.

In an embodiment, the inductor assembly further includes a conductive plate, the conductive plate is fixedly disposed on the support plate, a connecting terminal of the coil is electrically connected to the conductive plate, and the conductive plate is configured to be electrically connected to a wiring harness passing through the wiring hole.

In an embodiment, two conductive plates are provided, and are spaced apart by a block fixedly disposed on the support plate, the two conductive plates are in one-to-one correspondence to two connecting terminals of two coils, and each of the two connecting terminals are electrically connected to a respective one of the two conductive plates.

In an embodiment, a top surface of the support plate has an installation recess, and the conductive plate is fixed in the installation recess.

In an embodiment, the inductor assembly further includes a terminal bolt, the conductive plate has a connecting through hole, the terminal bolt passes through the connecting through hole and is threadedly connected to the support plate, and the terminal bolt is configured to be in contact with the wiring harness.

In an embodiment, the top surface of the support plate is provided with a support structure, and the support structure is configured to support the wiring harness passing through the wiring hole.

In an embodiment, at least one wall of the housing has a cooling channel.

In an embodiment, the inductor assembly further includes a wiring harness connector, the wiring harness connector is fixedly connected to an outer wall of the housing, the wiring harness connector has a support hole in communication with the wiring hole, and the support hole is configured for the wiring harness to pass through.

In an embodiment, the material of the magnetic core is silicon-iron alloy.

In an embodiment, the connecting member is in a shape of a U-shaped plate, and the connecting member is provided with an installation hole, and the inductor housing further includes a reinforcing plate connected to the connecting member and the housing separately.

The inductor device includes a wiring harness and the inductor assembly described above. One end of the wiring harness passes through the wiring hole of the inductor assembly and is electrically connected to the coil of the inductor module.

### BRIEF DESCRIPTION OF DRAWINGS

FIG. 1 is a first structure view of an inductor assembly according to an embodiment of the present disclosure.

FIG. 2 is a structure view of an inductor module according to an embodiment of the present disclosure.

FIG. 3 is an exploded view of an inductor assembly according to an embodiment of the present disclosure.

FIG. 4 is a sectional view of an inductor assembly according to an embodiment of the present disclosure.

FIG. 5 is a structure view of an inductor assembly according to an embodiment of the present disclosure, with an upper cover plate and a portable cover plate not shown.

FIG. 6 is a first structure view of a lower housing according to an embodiment of the present disclosure.

FIG. 7 is a structure view of a support plate according to an embodiment of the present disclosure.

FIG. 8 is a view showing the assembling of a lower housing and a wiring harness connector according to an embodiment of the present disclosure.

FIG. 9 is an exploded view of an inductor module according to an embodiment of the present disclosure.

FIG. 10 is a second structure view of a lower housing according to an embodiment of the present disclosure.

FIG. 11 is a schematic diagram showing the principle of a boost circuit according to an embodiment of the present disclosure.

FIG. 12 is an effective circuit diagram showing a charging process according to an embodiment of the present disclosure.

FIG. 13 is an effective circuit diagram showing a discharging process according to an embodiment of the present disclosure.

### REFERENCE LIST

1 inductor housing
11 housing
111 wiring hole
112 lower housing
113 upper cover plate
114 portable cover plate
12 connecting member
13 cooling channel
14 reinforcing plate
15 support column
2 inductor module
21 magnetic core
211 magnetic core upper yoke
212 magnetic core lower yoke
213 magnetic core central column
214 upper insulation plate
215 lower insulation plate
22 coil
221 connecting terminal
3 support plate
31 block
32 installation recess
33 heat dissipation structure
34 support structure
4 conductive plate
41 connecting through hole
5 terminal bolt
6 thermally conductive pad
7 wiring harness connector
71 support hole
8 sealing ring
9 cooling water nozzle
10 wiring harness
101 terminal
201 transistor
202 diode
203 capacitor
204 inductor
205 input terminal.

### DETAILED DESCRIPTION

In order to make the aspects, technical solutions, and advantages of the embodiments of the present disclosure clearer, the technical solutions in the embodiments of the present disclosure are described clearly and completely hereinafter in conjunction with the drawings in the embodiments of the present disclosure. Apparently, the described embodiments are a part of the embodiments of the present disclosure rather than all the embodiments. The components of the embodiments of the present disclosure typically described and shown in the drawings here can be disposed and designed in various different configurations.

It is to be noted that similar reference numerals and letters represent similar terms in the following drawings. Therefore, once an item is defined in a drawing, it does not need to be further defined or explained in subsequent drawings.

In the description of the present disclosure, it is to be noted that, the orientational or positional relationships indicated by terms “above”, “below”, “left”, “right”, “vertical”, “horizontal”, “inner”, “outer” and the like are based on the orientational or positional relationships shown in the drawings or the usual orientational or positional relationships of the product of the present disclosure when used, merely for ease of describing the present disclosure and simplifying the description, rather than indicating or implying that the referred device or element must have a specific orientation and is constructed and operated in a specific orientation, and thus they are not to be construed as limiting the present disclosure. In addition, the terms “first”, “second” and “third” are used only to distinguish between descriptions, and should not be construed as indicating or implying relative importance. In the description of the present disclosure, unless otherwise stated, “multiple” means two or more.

In the description of the present disclosure, it is to be noted that unless otherwise specified and limited, the terms “arrange” and “connection” should be understood broadly, for example, it can be a fixed connection, a detachable connection or an integrated connection; or it can be a mechanical connection or an electrical connection. Those of ordinary skill in the art can understand the specific meanings of the above terms in the present disclosure according to specific situations.

In the description of the present disclosure, unless otherwise expressly specified and limited, a first feature being “on” or “under” a second feature may include direct contact between the first and second features, and may also include the first and second features not in direct contact but in contact through another feature between them. Moreover, the first feature is “over”, “above” and “on” the second feature include that the first feature is directly above and obliquely above the second feature, or simply means that the first feature is horizontally higher than the second feature. The first feature is “beneath”, “below” and “under” the second feature include that the first feature is directly below and obliquely below the second feature, or simply means that the first feature has a lower level than the second feature.

The embodiments of the present disclosure are described in detail hereinafter, and examples of the embodiments are shown in the drawings, where the same or similar reference numerals throughout represent the same or similar components or components with the same or similar functions. The embodiments described hereinafter with reference to the drawings are exemplary and are only intended to explain the present disclosure, and thus cannot be understood as limitations to the present disclosure.

An inductor assembly is provided according to this embodiment, which can be easily installed on an assembly to which the inductor assembly is to be assembled and can be installed efficiently.

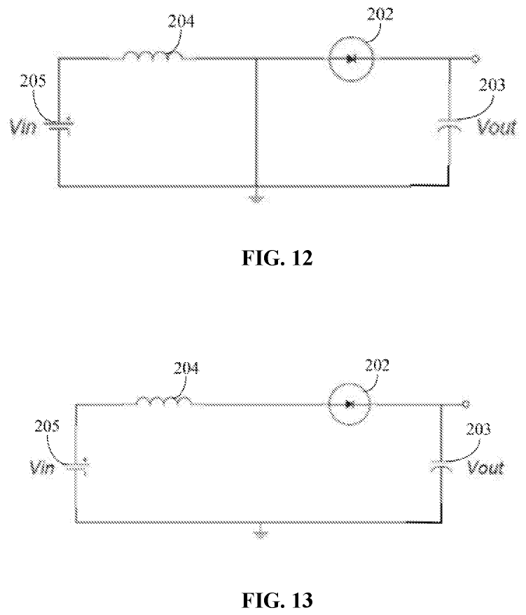

The inductor assembly in this embodiment can be a boost inductor. For ease of understanding, the boost inductor is introduced in this embodiment. FIG. 11 is a schematic diagram showing the principle of a boost inductor according to this embodiment. The boost inductor is used in conjunction with a switching device in a boost circuit to achieve an output voltage higher than an input voltage through charging and discharging. The boost circuit includes a transistor 201, a diode 202, a capacitor 203, an inductor 204 and an input terminal 205, the connection relationship of which is as shown in FIG. 11. FIG. 12 shows an effective circuit in a charging process. In the process of charging, the switch is switched on, that is, the transistor 201 is turned on, equivalent to replacing the transistor 201 with a wire. At this time, an input voltage of the input terminal 205 flows through the inductor 204. The diode 202 prevents the capacitor 203 from discharging electricity to ground. Since a direct current is input, a current on the inductor 204 increases linearly at a certain ratio related to the size of the inductor 204. As the current in the inductor 204 increases, some energy is stored in the inductor 204. It is to be noted that the capacitor 203 can serve as an output terminal. FIG. 13 shows an effective circuit of a discharging process. When the switch is switched off, that is, when the transistor 201 is turned off, due to the current retention characteristic of the inductor 204, the current flowing through the inductor 204 does not immediately become 0, but slowly changes from a value at the end of charging to 0. The original circuit has been broken, so the inductor 204 can only discharge through the new circuit, that is, the inductor 204 begins to charge the capacitor 203, and the voltage between two terminals of the capacitor 203 increases. At this time, the voltage is already higher than the input voltage, and the boost is finished. It can be seen that the boosting process is an energy transfer process of an inductor. When being charged, the inductor absorbs energy, and when being discharged, the inductor releases energy. If the capacitance is sufficiently large, a continuous current can be maintained at the output terminal in the process of discharging. If the process of turning on and off is repeated continuously, a voltage higher than the input voltage can be obtained between two terminals of the capacitor.

To be compatible with the existing 400V direct current (DC) fast charging piles, the 800V architecture must be equipped with a boost device to boost 400V DC to 800V DC to charge the battery pack. Currently, there are two solutions: boost DCDC and electric drive system reusing. In some solutions, the boost DCDC solution is adopted, where 800V DC can be directly charged into the power battery through the power distribution unit (PDU), achieving a charging power of 270 kW; 400V DC needs to be converted into 800V DC through the boost DCDC to achieve a charging power of 150 kW. In other embodiments, the solution of electric drive system reusing for voltage boosting is adopted. The charging platform boosts 400V to 800V through a rear axle drive motor and a boosting inverter. Currently, in some solutions, the stopped motor stator winding is used as an inductor, and some parts (such as diodes) of the electric drive system are reversely reused to form a boosting charging topology, which can increase the voltage of the charging pile from 500V to 750V. The boost inductor in the present disclosure pertains to the DCDC conversion solution here.

Moreover, the conventional high-power boost inductors mostly adopt amorphous magnetic cores. An amorphous material, featuring extremely high anti-saturation characteristics and superior performance of loss at high frequency to sendust, should have been the best choice, but has a large magnetostriction coefficient, often accompanied by large noise. Moreover, the amorphous materials are manufactured with strips having a thickness of above 20 μm and the eddy current loss of the strips is very small, however, when the strips are used as the inductor magnetic material, end faces have to be cut open due to the need for an air gap, resulting in a short circuit between end face layers. When higher ΔB (B represents the magnetic induction intensity) change (large inductor ripple) occurs, a large eddy current loss may occur at the cut end face of the magnetic core. As a result, the core loss of amorphous material is much higher than the loss of the sendust material under the same AB change. In addition, the efficiency of the inductor directly determines the conversion performance of charging energy, so the design of the inductor requires minimizing iron loss and copper loss as much as possible. The copper loss mainly includes:
1) a low-frequency DC loss caused by an effective value current flowing through a DC internal resistance;
2) a high-frequency alternating-current (ΔC) loss generated by skin effect of line caused by a high frequency AC component;
3) a high-frequency loss due to proximity effect, caused by the skin effect of high-frequency current, between winding layers; and
4) an eddy current loss caused by air gap leakage flux passing through the conductor.

Iron loss is mainly determined by the characteristics of magnetic materials. In order to reduce the iron loss, it is necessary to optimize the selection of materials with good high-frequency loss characteristics. The relationship between the magnitudes of losses of magnetic materials is: ferrite<amorphous<sendust<silicon-iron alloy<pure iron powder core. The most important purpose of high-frequency of the switching power supply is to minimize the energy storage passive component and energy exchange passive component in the circuit through high-frequency of the working frequency, to achieve the objects such as high efficiency, low cost, small size and fast response. Therefore, on the premise of ensuring performance without increasing additional costs, using smallest possible inductance is a basic requirement for the design of a boost inductor and a development trend of technology. However, though reducing the inductance without changing the frequency can significantly reduce the cost, the ripple current also increases accordingly. In this case, the increase of AB inside the magnetic material significantly increases the loss of the amorphous magnetic core, and a significant increase in the leakage flux component in the air gap of the amorphous magnetic core directly leads to the eddy current effect of the surrounding copper winding wires. Therefore, when the amorphous design is adopted, in order to avoid this issue, it is necessary to increase the inductance as much as possible to depress the current ripple so as to relief this burden. As a result, in order to improve efficiency, a large amount of copper material has to be used to increase the inductance while reducing the internal resistance. This is the fundamental reason why amorphous materials are not conducive to small inductance applications. To address this issue, a very good approach is to use a manner such as combining ferrite and sendust (or high-performance silicon-iron alloy materials). Through the hybrid magnetic circuit technology and based on the working characteristics of boost current, foster strengths and circumvent weaknesses is adopted, achieving both a reduction in inductance (small volume, low cost requirements) and a significant improvement in inductance loss.

In addition, conventional boost inductors are mostly in the form of independent magnetic cores paired with coils, which requires the use of other assemblies for installation and heat dissipation, and requires to be connected to high-voltage wiring harnesses via complex copper bars. The consideration and layout of the product is required in the early stages of design of the entire module, which limits the independence of designs of other assemblies.

The inductor assembly provided by embodiments of the present disclosure can address the above issues, and the inductor assembly is introduced in detail hereinafter.

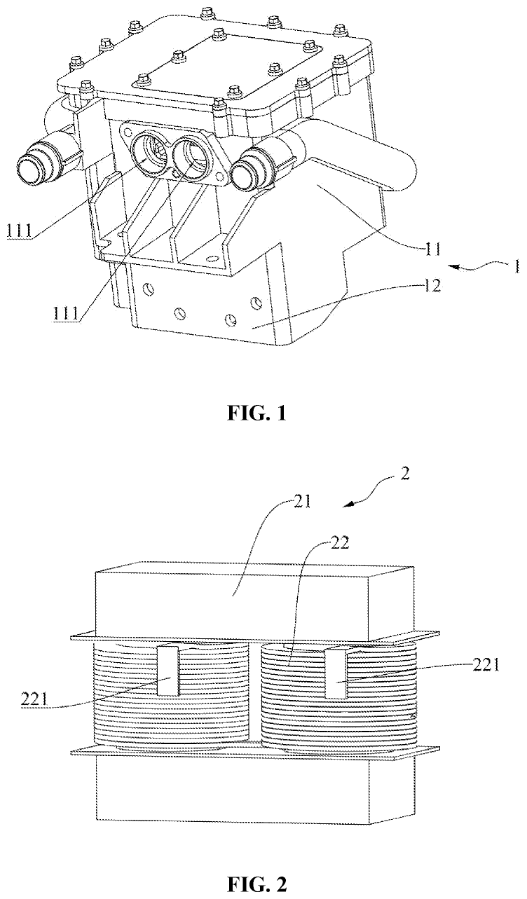

As shown in FIG. 1 and FIG. 2, the inductor assembly includes an inductor housing 1 and an inductor module 2.

The inductor housing 1 includes a housing 11 and a connecting member 12 which are integrally formed. The housing 11 is a sealed structure, and the shape of the housing 11 can be set according to practical requirements. In some embodiments, the housing 11 is in a square shape. The connecting member 12 is located outside the housing 11 and is connected to an outer wall of the housing 11. The housing 11 is hollow and is provided with a wiring hole 111 configured for a wiring harness 10 to pass through, to enable the wiring harness 10 to be electrically connected to the inductor module 2 inside the housing 11. The connecting member 12 is configured to connect to an object to be installed, that is, the inductor housing 1 in this embodiment can be directly installed to the object to be installed, without the need for other connection structures. In some embodiments, the connecting member 12 is provided with an installation hole, and the installation hole is configured for a structure such as a bolt to pass through, thus connecting the connecting member 12 to the object to be installed.

The inductor module 2 is fixedly installed inside the housing 11, enabling the housing 11 to seal the inductor module 2 so as to prevent dust, water, etc. from falling onto the inductor module 2. Moreover, the inductor module 2 includes a magnetic core 21 and a coil 22.

In the inductor assembly according to this embodiment, the inductor housing 1 is an integrated structure, and the inductor housing 1 includes the housing 11 and the connecting member 12. The housing 11 is a sealed structure, and can accommodate the inductor module 2 and provide a relatively sealed environment for the inductor module 2. The connecting member 12 can be directly connected to the object to be installed, thereby enabling the inductor housing 1 to be directly installed onto the object to be installed, reducing the installation steps, simplifying the installation process and improving the installation efficiency of the inductor assembly.

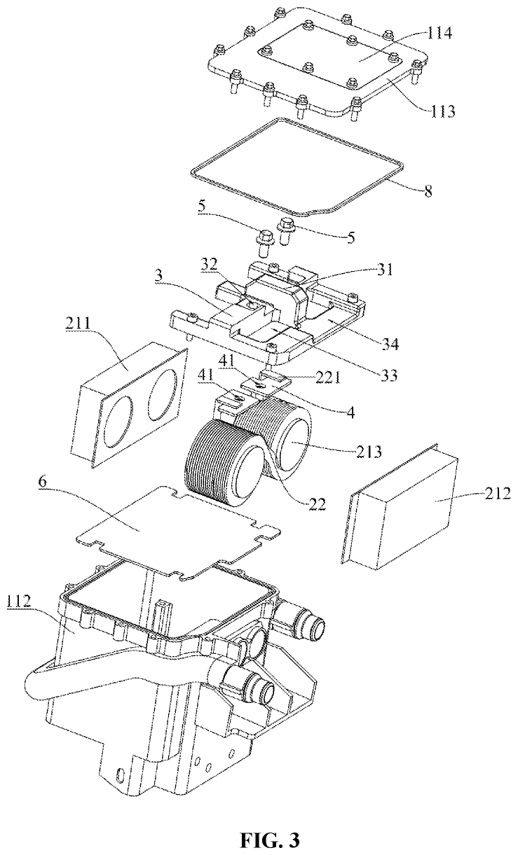

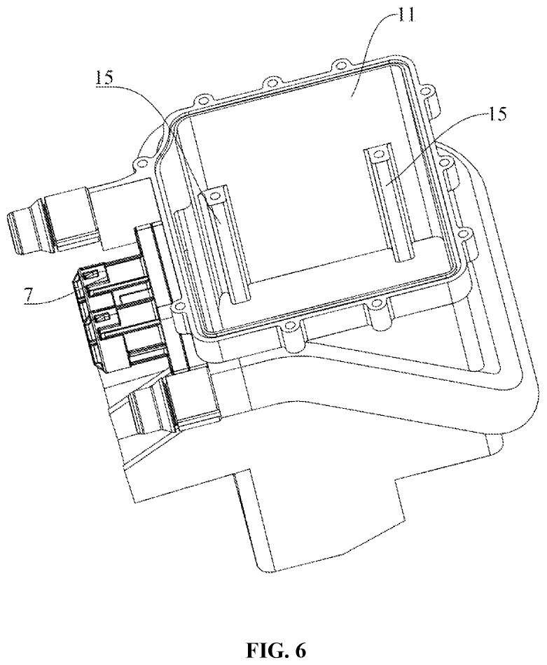

Optionally, as shown in FIG. 3 to FIG. 5, the inductor assembly further includes a support plate 3 fixedly installed inside the housing 11. The inductor module 2 can be limited by means of the support plate 3, that is, the support plate 3 limits the inductor module 2 inside the housing 11 to prevent the inductor module 2 from moving inside the housing 11. In some embodiments, the inductor module 2 is located below the support plate 3, that is, the bottom of the inductor module 2 is supported on the housing 11, and the top of the inductor module 2 is limited by the support plate 3. The support plate 3 is configured to limit the inductor module 2 in the height direction of the housing 11, and in the width and length directions of the housing 11, the inductor module 2 can be limited by the housing 11. For example, a limit block or other structures may be provided to abut against the inductor module 2, which is not limited in this embodiment. There can be various ways of fixing the support plate 3 inside the housing 11. In some embodiments, as shown in FIG. 6, a support column 15 is fixedly provided in the housing 11, and the support plate 3 is supported on the support column 15 and fixed on the support column 15 through bolts or other fixing components to facilitate the removal and replacement of the support plate 3.

Further, with continuous reference to FIG. 3. The inductor assembly further includes a conductive plate 4, and the conductive plate 4 is fixedly disposed on the support plate 3. A connecting terminal 221 of the coil 22 is electrically connected to the conductive plate 4, and the conductive plate 4 is configured to be electrically connected to the wiring harness 10 passing through the wiring hole 111 to achieve electrical connection between the coil 22 and the wiring harness 10. The setting of the conductive plate 4 achieves the connection between the coil 22 and the wiring harness 10, thereby avoiding heat concentration caused by directly opening hole for the connecting terminal 221, and improving the safety of the inductor assembly. In some embodiments, the conductive plate 4 is a copper bar. The wiring harness 10 is connected to the coil and is then connected to a system circuit at the other end to achieve electrical connection between the inductor assembly and an external system. It is to be noted that the wiring harness 10 can be installed by the client based on practical usage. In this embodiment, the conductive plate 4 is fixed on the top surface of the support plate 3, and the connecting terminal 221 of the coil 22 passes through the support plate 3 and is then electrically connected to the conductive plate 4, so that the support plate 3 can further support the connecting terminal 221. Thus, when the inductor assembly vibrates, the connecting terminal 221 is not apt to be separated from the conductive plate 4, thereby improving connection reliability.

With continuous reference to FIG. 3, two conductive plates 4 are provided, and the two conductive plates 4 are spaced apart from each other by a block 31 fixedly disposed on the support plate 3 to reduce the probability of a short circuit. Moreover, the two conductive plates 4 are in one-to-one correspondence to two connecting terminals 221 of coils 22, and each connecting terminal 221 is electrically connected to a corresponding conductive plate 4. Two wiring harnesses 10 are provided, and the two wiring harnesses are electrically connected to the two conductive plates 4 respectively to form a circuit.

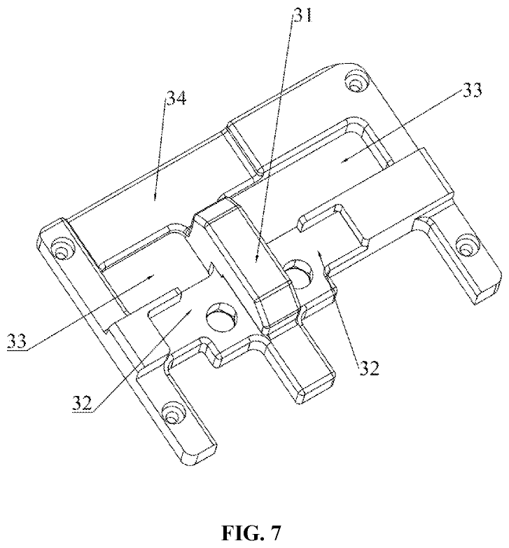

Optionally, as shown in FIG. 7, the top surface of the support plate 3 has an installation recess 32, and the conductive plate 4 is fixed in the installation recess 32. The installation recess 32 can limit and position the conductive plate 4, thereby facilitating the installation of the conductive plate 4. Moreover, the setting of the installation recess 32 ensures that the arrangement of the conductive plate 4 does not additionally occupy the internal space of the housing 11, so that the volume of the housing 11 can be made smaller, which facilitates the miniaturization of the inductor assembly. It is to be noted that when two conductive plates 4 are provided, two installation recesses 32 are provided correspondingly.

With continuous reference to FIG. 7, the support plate 3 has at least one heat dissipation structure 33, and the heat dissipation structure 33 is provided to run through the support plate 3 in the thickness direction of the support plate 3, so that the heat generated by the inductor module 2 can be transferred to an upper part of the support plate 3 through the heat dissipation structure 33, thereby improving the heat dissipation effect of the inductor module 2. As shown in FIG. 7, the heat dissipation structure 33 can be a hole opened in the support plate 3, or the heat dissipation structure 33 can also be a notch disposed in the support plate 3, which is not limited in this embodiment.

In this embodiment, reference is further made to FIG. 7. A top surface of the support plate 3 is provided with a support structure 34, and the support structure 34 is configured to support the wiring harness 10 passing through the wiring hole 111, to reduce the probability of breaking of the wiring harness 10 due to being bent and improve the reliability of the connection between the wiring harness 10 and the coil 22. The specific structure of the support structure 34 can be determined based on the height difference between the wiring hole 111 and the conductive plate 4 or based on the direction of the wiring harness 10. In some embodiments, as shown in FIG. 7, the support structure 34 is a recess, and in other embodiments, the support structure 34 is a protrusion.

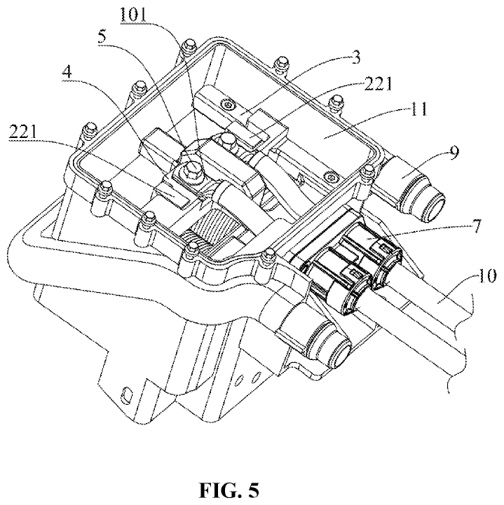

In some optional embodiments, as shown in FIG. 5, the inductor assembly further includes a terminal bolt 5, the conductive plate 4 has a connecting through hole 41, and the terminal bolt 5 passes through the connecting through hole 41 and is threadedly connected to the support plate 3 to fix the conductive plate 4 to the support plate 3. Additionally, the terminal bolt 5 is configured to be in contact with the wiring harness 10, to enable the wiring harness 10 to be electrically connected to the conductive plate 4 by means of the terminal bolt 5. In some embodiments, a terminal 101 of wiring harness 10 has a through hole, and the terminal bolt 5 also passes through the through hole of the terminal 101.

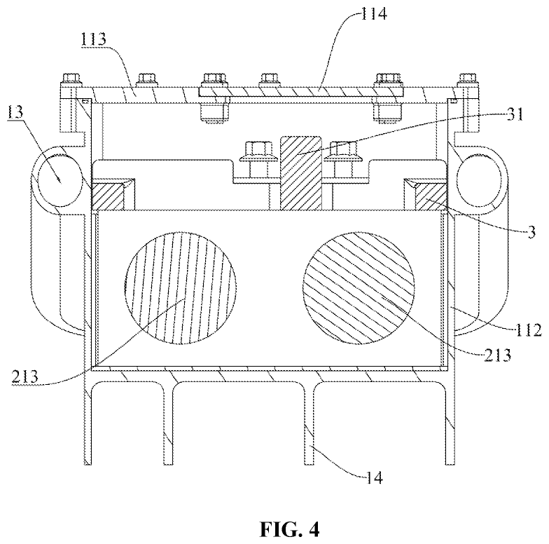

Δt least one wall of the housing 11 has a cooling channel 13. That is, the wall of the housing 11 is provided with a hole, and an extension direction of the hole is perpendicular to a wall thickness direction of the housing 11. The hole can form the cooling channel 13, thereby eliminating the need to fix a cooling pipe separately on the outer wall of the housing 11, achieving the versatility of the housing 11 and avoiding occupying too much space. The cooling channel 13 is configured for the flow of a coolant, and the coolant is used to cool the inductor module 2. As shown in FIGS. 4 and 5, three side walls of the housing 11 each have a cooling channel 13, and three cooling channels 13 are communicated sequentially. A port of the cooling channels 13 is connected to a cooling water nozzle 9 configured to connect to and communicate with a cooling pipe in the cooling loop. In this embodiment, the cooling channel 13 is disposed to be inclined to have a large cooling area.

Optionally, as shown in FIG. 3, the inductor assembly further includes a thermally conductive pad 6. The thermally conductive pad 6 is disposed between the inductor module 2 and at least one inner wall of the housing 11. The thermally conductive pad 6 is configured to transfer the heat generated by the inductor module 2 to the wall of the housing 11 to assist in heat dissipation. In this embodiment, the thermally conductive pad 6 is disposed between the bottom of the inductor module 2 and a bottom wall of the housing 11. The material of the thermally conductive pad 6 may be silica gel or rubber. In this case, the thermally conductive pad 6 can further act as a buffer to prevent hard contact between the inductor module 2 and the housing 11. Optionally, no thermally conductive pad 6 may be disposed between the inductor module 2 and the housing 11, and a buffer pad may be disposed between the inductor module 2 and the bottom wall of the housing 11. The buffer pad acts as a buffer between the inductor module 2 and the housing 11 to prevent the inductor module from directly contacting the housing 11.

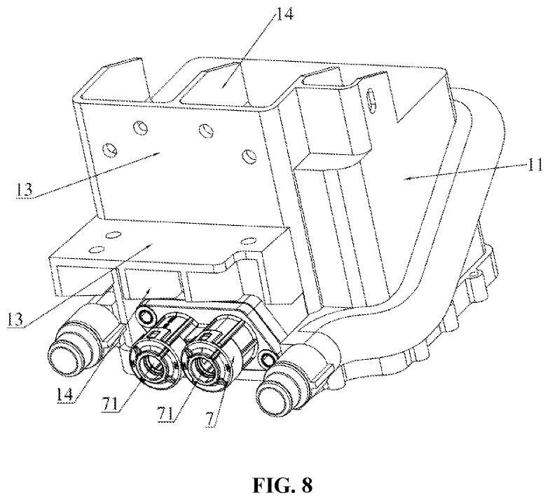

As shown in FIG. 8, the inductor assembly further includes a wiring harness connector 7, which is fixedly connected to the outer wall of the housing 11. In some embodiments, the wiring harness connector 7 is located on a wall of the housing 11 in which no cooling channel 13 is provided, and the wiring harness connector 7 has a support hole 71 in communication with the wiring hole 111, and the support hole 71 is configured for the wiring harness 10 to pass through. The wiring harness 10 can be supported by means of the support hole 71, thereby improving the stability of the wiring harness 10. Two wiring harness connectors 7 are provided, and are connected by a connecting plate, and the connecting plate is detachably connected to the housing 11.

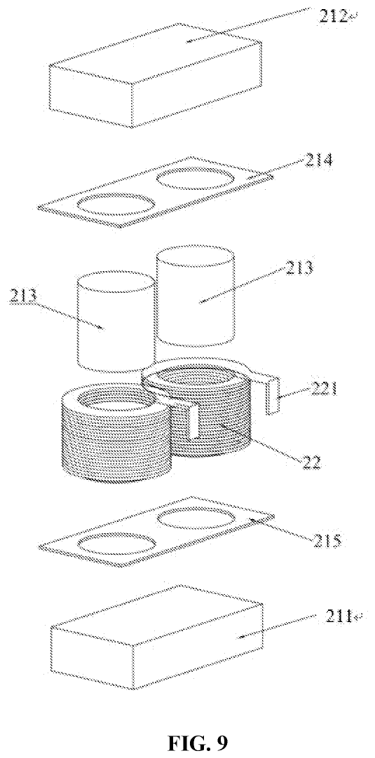

In this embodiment, the material of the magnetic core 21 is silicon-iron alloy, which enables the inductor module 2 to have a lower magnetic core loss while meeting the requirement for the inductance requirements. As shown in FIG. 9, the magnetic core 21 includes a magnetic core upper yoke 211, a magnetic core lower yoke 212, a magnetic core central column 213, an upper insulation plate 214, and a lower insulation plate 215. The material of each of the magnetic core upper yoke 211, the magnetic core lower yoke 212, and the magnetic core central column 213 is silicon-iron alloy. Two magnetic core central columns 213 are provided, and the coils 22 are wound on the two magnetic core central columns 213. The upper insulation plate 214 is configured to separate the magnetic core upper yoke 211 from the coils 22, and the lower insulation plate 215 is configured to separate the magnetic core lower yoke 212 from the magnetic core central columns 213, so as to provide insulation effect. Each coil 22 is formed by winding with a flat copper wire having a large cross-sectional area, which can effectively reduce the resistance of the copper wire and thus reducing losses.

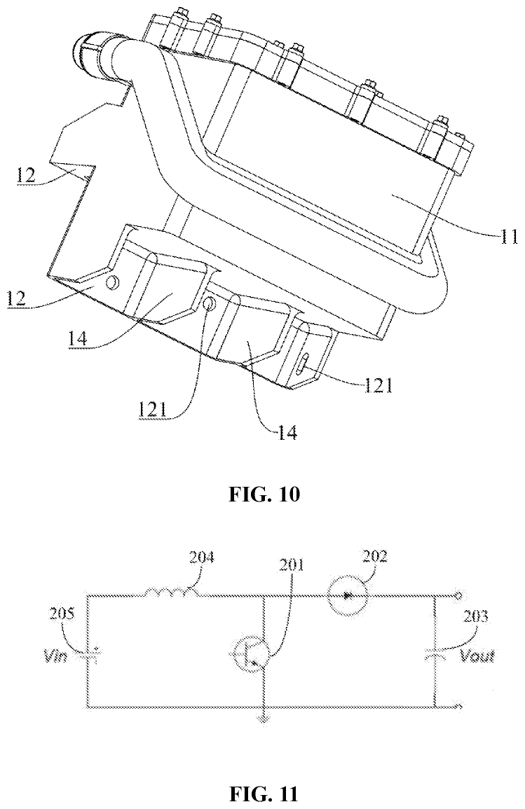

Optionally, as shown in FIG. 10, the connecting member 12 is in a shape of a U-shaped plate, and the connecting member 12 is perpendicular to the housing 11. The connecting member 12 is provided with an installation hole 121, and the installation hole 121 is configured for a bolt to pass through, so as to fix the connecting member 12 onto an object to be installed, by means of the bolt. Moreover, the inductor housing 1 further includes a reinforcing plate 14 connected to the connecting member 12 and the housing 11 separately, and the reinforcing plate 14 is configured to improve the connection strength between the connecting member 12 and the housing 11 and reduce the probability of separation of the connecting member 12 from the housing 11. In this embodiment, two connecting members 12 are provided on two adjacent walls of the housing 11 respectively. By connecting the two connecting members 12 to the object to be installed, the stability and reliability of the installation of the inductor assembly can be improved.

The housing 11 in this embodiment is a die-cast aluminum housing, and has a good thermal conductivity. Moreover, optionally, as shown in FIG. 4, the housing 11 includes a lower housing 112 having an opening, and an upper cover plate 113 that is connected to the opening of the lower housing 112 in a sealed manner. The upper cover plate 113 can be connected to the lower housing 112 by a bolt, a top end of the lower housing 112 further has a sealing groove, a sealing ring 8 is installed in the sealing groove to seal a gap between the lower housing 112 and the upper cover plate 113, so as to achieve dust proof and water proof of the entire inductor assembly. Optionally, the sealing ring 8 can be formed by applying rubber into the sealing groove through a dispensing apparatus.

With continuous reference to FIG. 7, the upper cover plate 113 has an opening at a position corresponding to the wiring position (i.e., the position where the conductive plate 4 is located). A portable cover plate 114 is installed in a sealed manner at the opening. The portable cover plate 114 can facilitate the disassembling and assembling in subsequent using, that is, the connection between the wiring harness 10 and the conductive plate 4 can be implemented without removing the entire upper cover plate 113.

The inductor assembly provided by the embodiments uses silicon-iron alloy as magnetic core material, which effectively reduces magnetic loss and reduces heat generation during product operation. Moreover, the creative integration design of the cooling channel 13 with the housing 11 effectively addresses the issue that the inductor module 2 generates a large amount of heat when a large current passes through the inductor module in the process of fast charging and the heat dissipation effect is poor. In addition, With the conductive plate 4, it is effectively ensured that there is a sufficient cross-sectional area for the current to pass through in the process of wiring between the connecting terminal and the high-voltage wiring harness 10, thereby avoiding the issue of heat concentration at the location of wiring.

An inductor device is further provided according to the embodiments. The inductor device includes a wiring harness 10 and the inductor assembly described above. One end of the wiring harness 10 passes through the wiring hole 111 of the inductor assembly and is electrically connected to the coil 22 of the inductor module 2.

The inductor device provided by the embodiments can occupy a small space and can be easily installed on a vehicle or other objects to be installed.

The preceding embodiments illustrate only the basic principles and features of the present disclosure.

It is to be noted that the above are merely preferred embodiments of the present disclosure and the technical principles used therein. It may be appreciated by the person skilled in the art that the present disclosure is not limited to the embodiments described herein. Therefore, although the present disclosure has been described in detail through the above embodiments, the present disclosure is not limited to the above embodiments and may include more other equivalent embodiments without departing from the concept of the present disclosure.

What is claimed is:

1. An inductor assembly, comprising:
an inductor housing, comprising a housing and a connecting member which are integrally formed, wherein the housing is a sealed structure, the connecting member is located outside the housing, the housing is hollow and provided with a wiring hole, and the connecting member is configured to connect to an object to be installed; and
an inductor module fixedly installed in the housing, and comprising a magnetic core and a coil.

2. The inductor assembly according to claim 1, further comprising a support plate fixedly installed inside the housing, wherein the support plate is configured to limit the inductor module inside the housing.

3. The inductor assembly according to claim 2, further comprising a conductive plate, wherein the conductive plate is fixedly disposed on the support plate, a connecting terminal of the coil is electrically connected to the conductive plate, and the conductive plate is configured to be electrically connected to a wiring harness passing through the wiring hole.

4. The inductor assembly according to claim 3, wherein two conductive plates are provided, and are spaced apart from each other by a block fixedly disposed on the support plate, the two conductive plates are in one-to-one correspondence to two connecting terminals of two coils, and each of the two connecting terminals are electrically connected to a respective one of the two conductive plates.

5. The inductor assembly according to claim 3, wherein a top surface of the support plate has an installation recess, and the conductive plate is fixed in the installation recess.

6. The inductor assembly according to claim 3, further comprising a terminal bolt, wherein the conductive plate has a connecting through hole, the terminal bolt passes through the connecting through hole and is threadedly connected to the support plate, and the terminal bolt is configured to be in contact with the wiring harness.

7. The inductor assembly according to claim 2, wherein a top surface of the support plate is provided with a support structure configured to support a wiring harness passing through the wiring hole.

8. The inductor assembly according to claim 1, wherein at least one wall of the housing has a cooling channel.

9. The inductor assembly according to claim 8, wherein a plurality of cooling channels are provided and are communicated sequentially, and a port of the plurality of cooling channels is connected with a cooling water nozzle.

10. The inductor assembly according to claim 1, further comprising a wiring harness connector, wherein the wiring harness connector is fixedly connected to an outer wall of the housing and has a support hole in communication with the wiring hole, and the support hole is configured for a wiring harness to pass through.

11. The inductor assembly according to claim 1, wherein the connecting member is in a shape of a U-shaped plate, and is provided with an installation hole.

12. The inductor assembly according to claim 11, wherein the inductor housing further comprises a reinforcing plate connected to the connecting member and the housing separately.

13. The inductor assembly according to claim 2, wherein the support plate has at least one heat dissipation structure, and the heat dissipation structure is provided to run through the support plate in a thickness direction of the support plate.

14. The inductor assembly according to claim 3, wherein the housing comprises a lower housing and an upper cover plate connected to an opening of the lower housing in a sealed manner, the upper cover plate is connected to the lower housing by a bolt, a top end of the lower housing further has a sealing groove, and a sealing ring is installed in the sealing groove.

15. The inductor assembly according to claim 14, wherein the upper cover plate is provided with an opening enabling the conductive plate to be exposed, and portable cover plate is installed at the opening in a sealed manner.

16. The inductor assembly according to claim 1, wherein the magnetic core comprises a magnetic core upper yoke, a magnetic core lower yoke, a magnetic core central column, an upper insulation plate, and a lower insulation plate, the coil is wound on the magnetic core central column, the magnetic core upper yoke abuts an end of the magnetic core central column, the upper insulation plate is sleeved on the magnetic core central column and located between the magnetic core upper yoke and the coil, the magnetic core lower yoke abuts another end of the magnetic core central column, the lower insulation plate is sleeved on the magnetic core central column and located between the magnetic core lower yoke and the coil.

17. The inductor assembly according to claim 16, wherein a material of the magnetic core central column, a material of the magnetic core upper yoke and a material of the magnetic core lower yoke are each silicon-iron alloy.

18. The inductor assembly according to claim 2, wherein a support column is provided in the housing, and the support plate is supported on the support column.

19. The inductor assembly according to claim 2, further comprising: a thermally conductive pad disposed between the inductor module and at least one inner wall of the housing.

20. An inductor device, comprising a wiring harness and the inductor assembly according to claim 1, wherein one end of the wiring harness passes through the wiring hole of the inductor assembly and is electrically connected to the coil of the inductor module.
